(19) United States
(12) Patent Application Publication
(10) Pub. No.: US 2022/0373833 A1
(43) Pub. Date: Nov. 24, 2022

(54) ELECTRONIC DEVICE AND DISPLAY PROJECTION SYSTEM

(71) Applicant: TPK Touch Systems (Xiamen) Inc., Xiamen (CN)

(72) Inventors: Jun Jie Zheng, Quanzhou City (CN); Yan Jun Xie, Xiamen City (CN); Jun Ping Yang, Longhai City (CN); Ning Zhang, Putian City (CN); Qi Jun Zheng, Xiamen City (CN); Liu Kun Wu, Xiamen City (CN); Wei Peng Liu, Xiamen City (CN); Xiao Xin Bai, Xiamen City (CN)

(21) Appl. No.: 17/326,549

(22) Filed: May 21, 2021

(51) Int. Cl. G02F 1/1333; G06F 3/041; G06F 3/044; G02F 1/1334

(52) U.S. Cl. CPC G02F 1/13338; G06F 3/0412; G06F 3/0443; G02F 1/1334; G06F 2203/04112

(57) ABSTRACT

An electronic device includes an integrated circuit and a smart film layer. Integrated circuit is configured to output a control signal. Smart film layer is coupled to integrated circuit and includes a first substrate, a second substrate, a liquid crystal layer, a transparent glue layer, a cover, and at least one touch electrode layer. Second substrate is located on first substrate. Liquid crystal layer is located between first substrate and second substrate. Transparent glue layer is located on second substrate. Cover is located on transparent glue layer. At least one touch electrode layer is located between two of first substrate, second substrate, liquid crystal layer, transparent glue layer, or cover. At least one touch electrode layer is configured to transmit a touch signal or at least one touch electrode layer is configured to control liquid crystal layer to present in transparent states according to control signal of integrated circuit.

### BACKGROUND

### Field of Disclosure

The present disclosure relates to an electronic device and a system. More particularly, the present disclosure relates to an electronic device and a display projection system.

### Description of Related Art

In an electronic device with a smart glass or smart film, if an electronic device is implemented with a touch function, touch electrodes/sensors need to be attached to a film or a glass structure using an out-cell method. Therefore, the aforementioned structure occupies an inner space of an electronic device. The inner space of the electronic device therefore cannot be used efficiently.

In addition, due to changes in the ambient light, smart glass/smart film displays are not clear and a color saturation of a display screen is insufficient.

For the foregoing reason, there is a need to provide some other suitable a smart glass or smart film structure to solve the problems of designs of inner space of an electronic device.

### SUMMARY

One aspect of the present disclosure provides an electronic device. The electronic device includes an integrated circuit and a smart film layer. The integrated circuit is configured to output a control signal. The smart film layer is coupled to the integrated circuit and includes a first substrate, a second substrate, a liquid crystal layer, a transparent glue layer, a cover, and at least one touch electrode layer. The second substrate is located on the first substrate. The liquid crystal layer is located between the first substrate and the second substrate. The transparent glue layer is located on the second substrate. The cover is located on the transparent glue layer. The at least one touch electrode layer is located between two of the first substrate, the liquid crystal layer, the second substrate, the transparent glue layer, or the cover. The at least one touch electrode layer is configured to transmit a touch signal according to the control signal of the integrated circuit, or the at least one touch electrode layer is configured to control the liquid crystal layer to present a plurality of transparent states according to the control signal of the integrated circuit.

Another aspect of the present disclosure relates to a display projection system. The display projection system includes an electronic device and a projector. The electronic device includes an integrated circuit, an optical sensor, and a smart film layer. The integrated circuit is configured to output a control signal. The optical sensor is coupled to the integrated circuit and is configured to sense an intensity of a light source. The smart film layer is coupled to the integrated circuit and is configured to transmit a touch signal according to the control signal or control a liquid crystal layer of the smart film layer to present a plurality of transparent states. The projector is coupled to the integrated circuit and is configured to project an image on the smart film layer of the electronic device. The optical sensor is configured to sense the intensity of a light source so as to control the liquid crystal layer of the smart film layer to present the plurality of transparent states through the integrated circuit according to the intensity of the light source.

It is to be understood that both the foregoing general description and the following detailed description are by examples and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 depicts a schematic diagram of part of an electronic device according to one embodiment of the present disclosure;

FIG. 2 depicts a schematic diagram of part of an electronic device according to one embodiment of the present disclosure;

FIG. 3 depicts a schematic diagram of part of an electronic device according to one embodiment of the present disclosure;

FIG. 4 depicts a schematic diagram of part of an electronic device according to one embodiment of the present disclosure;

FIG. 5 depicts a schematic diagram of a top view of part of an electronic device according to one embodiment of the present disclosure;

FIG. 6 depicts a circuit block diagram of an electronic device according to one embodiment of the present disclosure;

FIG. 7 depicts a schematic diagram of part of an electronic device according to one embodiment of the present disclosure; and

FIG. 8 depicts a circuit block diagram of a display projection system according to one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The terminology used herein is for the purpose of describing particular example embodiments only and is not intended to be limiting of the present disclosure. As used herein, the singular forms “a,” “an”, and “the” are intended to include the plural forms as well, unless the context clearly indicates otherwise.

Furthermore, it should be understood that the terms, “comprising”, “including”, “having”, “containing”, “involving”, and the like, used herein are open-ended, that is, including but not limited to.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

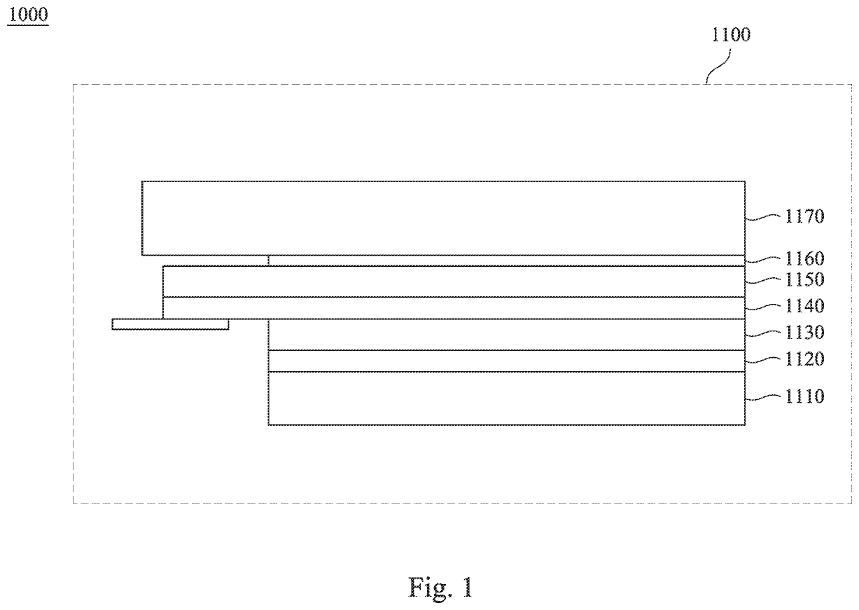

FIG. 1 depicts a schematic diagram of part of an electronic device 1000 according to one embodiment of the present disclosure. In some embodiments, as shown in FIG. 1, the electronic device 1000 includes a smart film layer 1100. The smart film layer 1100 includes a first substrate 1110, at least one conductive layer 1120, a liquid crystal layer 1130, at least one touch electrode layer 1140, a second substrate 1150, a transparent glue layer 1160, and a cover 1170 from the bottom to the top of FIG. 1. The second substrate 1150 is located on the first substrate 1110. The liquid crystal layer 1130 is located between the first substrate 1110 and the second substrate 1150. The transparent glue layer 1160 is located on the second substrate 1150. The cover 1170 is located on the transparent glue layer 1160.

In some embodiments, each of the first substrate 1110 and the second substrate 1150 includes one of a glass substrate or a polymer substrate.

In some embodiments, the liquid crystal layer 1130 includes one of polymer dispersed liquid crystal (PDLC) or Multiple Stability Liquid Crystal (MSLC). The polymer dispersed liquid crystal (PDLC) is an anisotropic liquid crystal and is uniformly dispersed in a polymer composite film. The polymer dispersed liquid crystal (PDLC) is controlled to adjust a refractive index between liquid crystals and polymers so as to cause light scattering and light transmission according to an applied electric field.

In some embodiments, the at least one conductive layer 1120 includes one of Indium Tin Oxide (ITO), nano silver, or metal mesh. In some embodiments, the at least one touch electrode layer 1140 includes one of Indium Tin Oxide (ITO), nano silver, or metal mesh. In some embodiments, metal mesh includes extremely thin copper wires (Cu). It should be noted that materials of the at least one conductive layer 1120 and the at least one touch electrode layer 1140 can be designed according to the actual needs and is not limited to the embodiment shown in FIG. 1 and the embodiments of the present disclosure.

In some embodiments, the transparent glue layer 1160 includes optically clear adhesive (OCA).

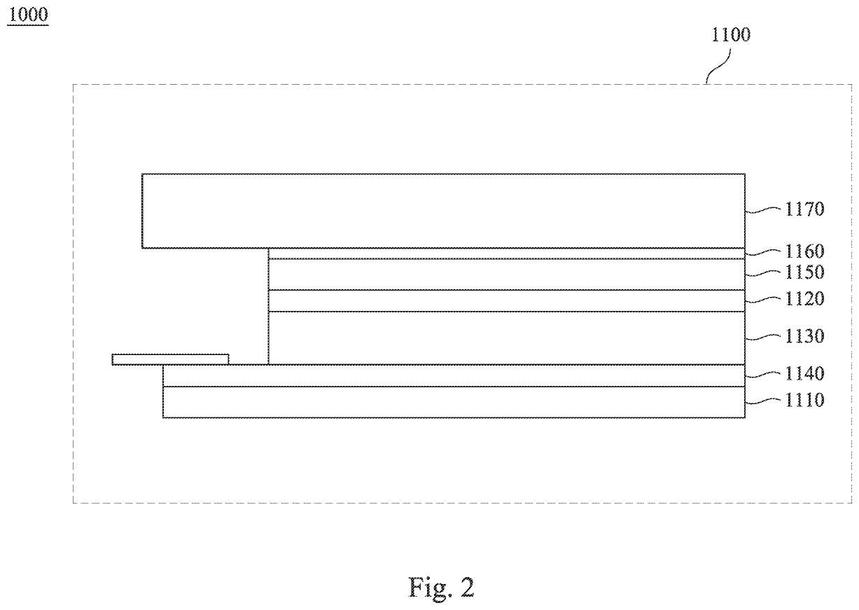

FIG. 2 depicts a schematic diagram of part of an electronic device 1000 according to one embodiment of the present disclosure. Compared to FIG. 1, the embodiment of FIG. 2 only swaps the at least one conductive layer 1120 and the at least one touch electrode layer 1140. The structure and the function of the remaining parts of the electronic device 1000 is the same as the embodiment in FIG. 1, and repetitious details are omitted herein.

In some embodiments, with reference to FIG. 1 and FIG. 2, when the at least one touch electrode layer 1140 is located between the first substrate 1110, the liquid crystal layer 1130, and the second substrate 1150, the at least one touch electrode layer 1140 has two functions. The at least one touch electrode layer 1140 is configured to transmit the touch signal when in a non-conductive state. The at least one touch electrode layer 1140, when in a conductive state, is configured to control the liquid crystal layer 1130 to present a plurality of transparent states. The liquid crystal layer 1130 presents different transparent states under different voltages. A range of a transparency of the transparent states is between 0% and 100%. When the transparency of the liquid crystal layer 1130 is 100%, the liquid crystal layer 1130 is completely transparent. When the at least one touch electrode layer 1140 is in the non-conductive state, the transparency of the liquid crystal layer 1130 is 0%, the liquid crystal layer 1130 is completely nontransparent, the liquid crystal layer 1130 appears milky white, and at the same time, the at least one touch electrode layer 1140 is only configured to transmit the touch signal.

In some embodiments, referring to FIG. 2, the liquid crystal layer 1130 includes a first side (as shown at the bottom of the Figure) and a second side (as shown at the top of the Figure). The first side is opposite to the second side. The at least one conductive layer 1120 is located at the first side of the liquid crystal layer 1130. The at least one touch electrode layer 1140 is located at the second side of the liquid crystal layer 1130.

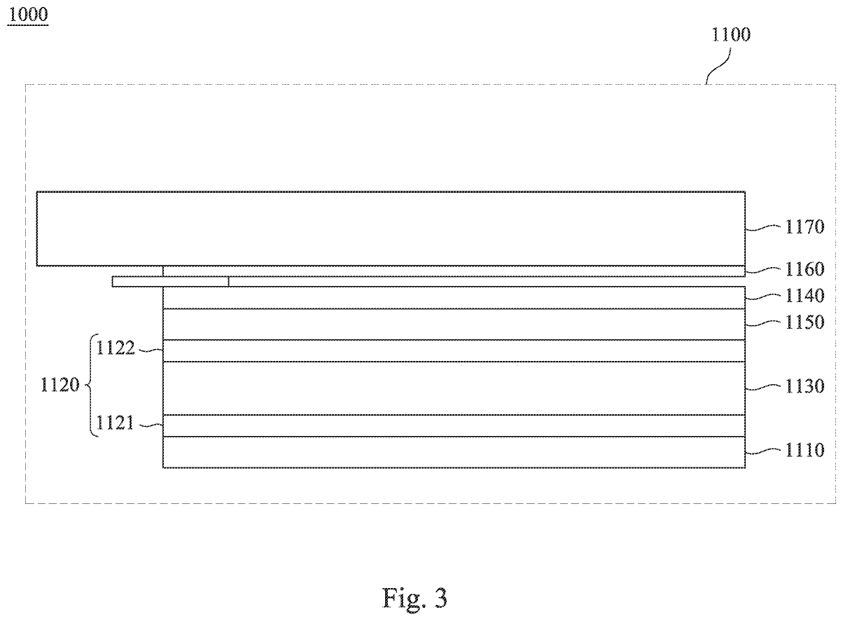

FIG. 3 depicts a schematic diagram of part of an electronic device 1000 according to one embodiment of the present disclosure. In some embodiments, compared to FIG. 1 and FIG. 2, when the at least one touch electrode layer 1140 is located between the second substrate 1150, the transparent glue layer 1160, and the cover 1170, the at least one conductive layer 1120 includes a first conductive layer 1121 and a second conductive layer 1122. The first conductive layer 1121 is located at the first side of the liquid crystal layer 1130 (as shown at the bottom of the Figure). The second conductive layer 1122 is located at the second side of the liquid crystal layer 1130 (as shown at the top of the Figure). The first conductive layer 1121 and the second conductive layer 1122 are configured to control the liquid crystal layer 1130 to present the plurality of transparent states together. The structure and the function of the remaining parts of the electronic device 1000 is the same as the embodiment in FIG. 1, and repetitious details are omitted herein.

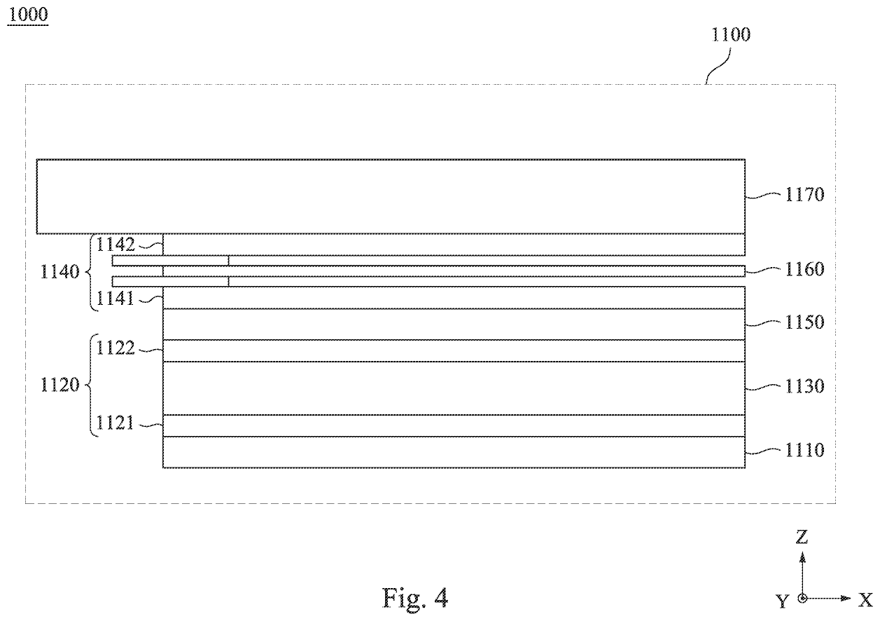

FIG. 4 depicts a schematic diagram of part of an electronic device 1000 according to one embodiment of the present disclosure. In some embodiments, compared to FIG. 3, the at least one touch electrode layer 1140 includes first direction electrodes 1141 and second direction electrodes 1142. The first direction electrodes 1141 are located between the second substrate 1150 and the transparent glue layer 1160. The second direction electrodes 1142 are located between the transparent glue layer 1160 and the cover 1170. The first direction electrodes 1141 and the second direction electrodes 1142 are not parallel with each other. In some embodiments, the first direction electrodes 1141 extend along an X axis direction, and the second direction electrodes 1142 extend along a Y axis direction. The structure and the function of the remaining parts of the electronic device 1000 is the same as the embodiment in FIG. 1, and repetitious details are omitted herein. It should be noted that any or all of the at least one touch electrode layer 1140 of the embodiments shown in FIG. 1 and FIG. 3 can include electrodes extending along the X axis direction and the Y axis direction.

In some embodiments, with reference to FIG. 3 and FIG. 4, when the at least one touch electrode layer 1140 is located between the second substrate 1150, the transparent glue layer 1160, and the cover 1170, the electronic device 1000 can be touched and the transparency of the liquid crystal layer 1130 can be controlled at the same time.

In some embodiments, referring to FIG. 1 to FIG. 4, based on the aforementioned embodiments, positions of the at least one touch electrode layer 1140 can be located between two of the first substrate 1110, the liquid crystal layer 1130, the second substrate 1150, the transparent glue layer 1160, or the cover 1170.

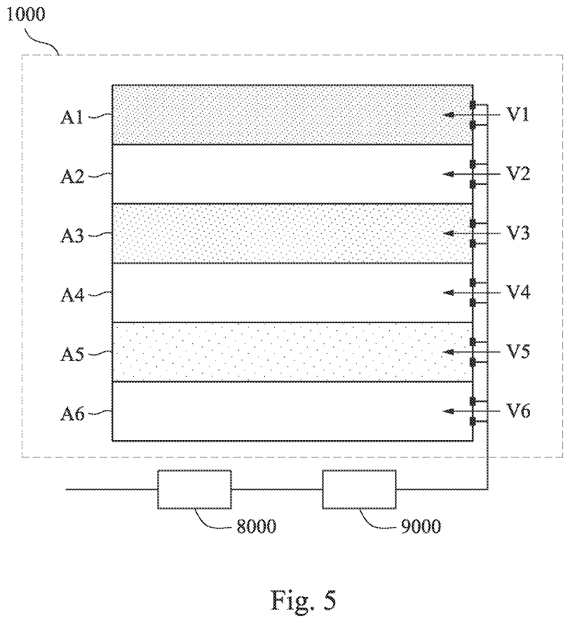

FIG. 5 depicts a schematic diagram of a top view of part of an electronic device 1000 according to one embodiment of the present disclosure. The electronic device 1000 includes a first area A1, a second area A2, a third area A3, a fourth area A4, a fifth area A5, and a sixth area A6. In some embodiments, a transformer 8000 is configured to receive alternating-current (AC) voltages so as to convert the AC voltages to a voltage required by a controller 9000. The controller 9000 send input voltages V1 to V6 to the areas A1 to A6 respectively. It should be noted that a number, a shape, and a size of the areas A1 to A6 shown in the electronic device 1000 are not limited to the embodiment shown in FIG. 5.

In some embodiments, with reference to FIG. 1 to FIG. 5, each of the first area A1, the second area A2, the third area A3, the fourth area A4, the fifth area A5, and the sixth area A6 of the electronic device 1000 includes the smart film layer 1100 of the embodiments shown in FIG. 1 to FIG. 4 respectively. For example, the first area A1 of the electronic device 1000 includes the smart film layer 1100 shown in FIG. 1. The second area A2 of the electronic device 1000 includes the smart film layer 1100 shown in FIG. 2. The third area A3 of the electronic device 1000 includes the smart film layer 1100 shown in FIG. 3. The fourth area A4 of the electronic device 1000 includes the smart film layer 1100 shown in FIG. 4.

In addition, with reference to FIG. 5, the first area A1, the second area A2, the third area A3, the fourth area A4, the fifth area A5, and the sixth area A6 are independent with each other. The smart film layer 1100 in each area is configured to receive the same voltage or different voltages so as to control the liquid crystal layer 1130 to present the transparent states. For example, the first area A1 is configured to receive an input voltage V1. The second area A2 is configured to receive an input voltage V2. The third area A3 is configured to receive an input voltage V3. The fourth area A4 is configured to receive an input voltage V4. The fifth area A5 is configured to receive an input voltage V5. The sixth area A6 is configured to receive an input voltage V6.

Furthermore, since the smart film layer 1100 is configured to receive the same voltage or different voltages, the transparent states of the liquid crystal layer 1130 in each area can be the same or different. For example, the liquid crystal layer 1130 of the first area A1 presents in a first transparent state. The liquid crystal layer 1130 of the second area A2 presents in a second transparent state. The liquid crystal layer 1130 of the third area A3 presents in a third transparent state. The liquid crystal layer 1130 of the fourth area A4 presents in a fourth transparent state. The first transparent state, the second transparent state, the third transparent state, and the fourth transparent state are the same or different. The transparent states are not limited to the figure.

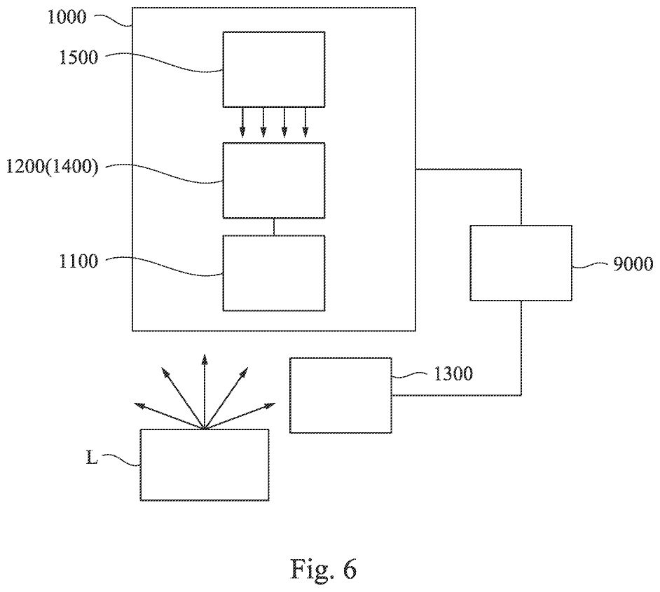

FIG. 6 depicts a circuit block diagram of an electronic device 1000 according to one embodiment of the present disclosure. In some embodiments, the electronic device 1000 of FIG. 6 is corresponding to the electronic device 1000 shown in FIG. 1 to FIG. 5. The electronic device 1000 includes a smart film layer 1100 and an integrated circuit (IC) 1200. The integrated circuit 1200 is configured to output a control signal. The smart film layer 1100 is coupled to the integrated circuit 1200. With reference to FIG. 1 and FIG. 5, the at least one touch electrode layer 1140 of the smart film layer 1100 is configured to transmit a touch signal according to a control signal of the integrated circuit 1200, or the at least one touch electrode layer 1140 of the smart film layer 1100 is configured to control a liquid crystal layer 1130 to present a plurality of transparent states according to the control signal from the integrated circuit 1200. The electronic device 1000 further includes a first optical sensor 1300, a second optical sensor 1400, and a backlight plate 1500. The first optical sensor 1300 is coupled to the integrated circuit 1200 and is configured to sense an intensity of a light source L so as to control the smart film layer 1100 to present the transparent states through the integrated circuit 1200 according to the intensity of the light source L. It should be noted that a position of the first optical sensor 1300 can be located on the electronic device 1000 or outside the electronic device 1000 and is not limited to what is shown in the figure.

In addition, at least one conductive layer 1120 and at least one touch electrode layer 1140 of the smart film layer 1100 are coupled to a flexible printed circuit board (FPC) (not shown in the figure) and the integrated circuit 1200.

Moreover, each of the second optical sensor 1400 and the backlight plate 1500 is coupled to the integrated circuit 1200. The second optical sensor 1400 is located between the backlight plate 1500 and the smart film layer 1100 and is configured to sense an intensity of the backlight plate 1500, so as to control the smart film layer 1100 to present the transparent states and control a luminance of the backlight plate 1500 through the integrated circuit 1200 according to the intensity of the backlight plate 1500.

In detail, the first optical sensor 1300 is configured to sense the intensity of the light source L so as to generate a light intensity signal to a controller 9000. The controller 9000 receives the light intensity signal so as to adjust a current value flowing through the backlight plate 1500 according to a built-in logic program. When the current value flowing through the backlight changes, the intensity of the backlight plate 1500 is changed according to the current value. The second optical sensor 1400 is configured to receive the intensity of the backlight plate 1500 so as to generate a light intensity signal to feed the light intensity signal back to the controller 9000. The controller 9000 is configured to control the smart film layer 1100 through the integrated circuit 1200 according to the light intensity signals from the first optical sensor 1300 and the second optical sensor 1400.

In some embodiments, the light source L includes a point light source, a diffuse light source, and/or a parallel light. The light source L is not limited to the embodiments shown in the figure.

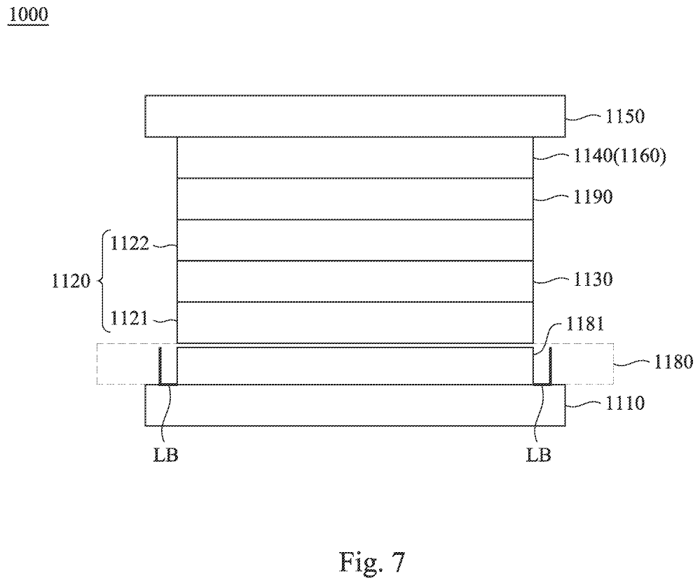

FIG. 7 depicts a schematic diagram of part of an electronic device 1000 according to one embodiment of the present disclosure. In some embodiments, compared to FIG. 4, the electronic device 1000 only adds a three-dimensional (3D) light guide plate 1180 and a color filter 1190. The 3D light guide plate 1180 includes a light guide plate 1181 and two light bars LB located at both sides of the light guide plate 1181. The structure and the function of the remaining parts of the electronic device 1000 is the same as the embodiment in FIG. 4, and repetitious details are omitted herein.

In some embodiments, in one three dimension (3D) mode, light emitted by the two light bars LB located at both sides of the light guide plate 1181 is projected upward through patterns on the light guide plate 1181. Since a surface of the light guide plate 1181 is corrugated or bumpy or uneven, projection angles of light emitted from the light guide plate 1181 are different. When the light enters the human eye, the light makes people feel that the images or patterns have a naked eye 3D effect.

In addition, the patterns on the light guide plate 1181 correspond to pixels of cells of the electronic device 1000. Therefore, light emitted from the light guide plate 1181 matches the pixels of the cells to form a colorful naked eye 3D pictures

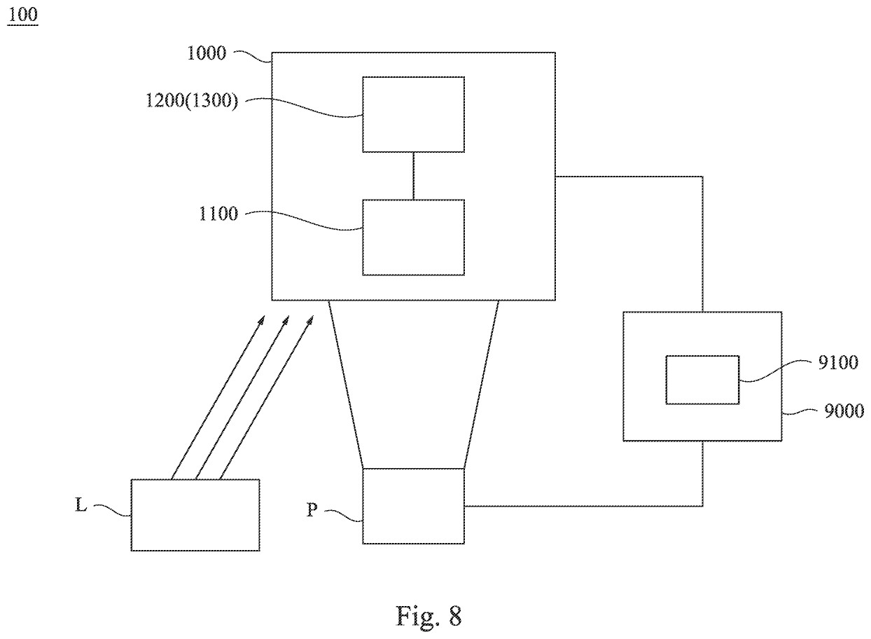

FIG. 8 depicts a circuit block diagram of a display projection system 100 according to one embodiment of the present disclosure. In some embodiments, the display projection system 100 includes an electronic device 1000 and a projector P. The electronic device 1000 includes a smart film layer 1100, an integrated circuit 1200, and an optical sensor 1300. The integrated circuit 1200 is configured to output a control signal. The optical sensor 1300 is coupled to the integrated circuit 1200 and is configured to sense a light intensity. The smart film layer 1100 is coupled to the integrated circuit 1200. The smart film layer 1100 is configured to transmit a touch signal according to the control signal of the integrated circuit 1200 or control a liquid crystal layer of the smart film layer 1100 to present a plurality of transparent states according to the control signal of the integrated circuit 1200. The projector P is coupled to the integrated circuit 1200 and is configured to project an image on the smart film layer 1100 of the electronic device 1000. The optical sensor 1300 is configured to sense an intensity of a light source L through the integrated circuit 1200 so as to control the liquid crystal layer of the smart film layer 1100 to present the transparent states according the intensity of the light source L.

In detail, the optical sensor 1300 is configured to sense an intensity of the light source L so as to generate a light intensity signal to the controller 9000. The controller 9000 receives the light intensity signal and controls a voltage controller 9100 according to a built-in program. The voltage controller 9100 is configured to sense a frequency of the output signal from the controller 9000 so as to control a voltage to the electronic device 1000 in real time. The voltage controller 9100, which is coupled to the integrated circuit 1200, controls the liquid crystal layer of the smart film layer 1100 to present the transparent states according to the light intensity signal. When the intensity of the light source L is too strong, the voltage controller 9100 reduces a transparency of the liquid crystal layer of the smart film layer 1100 through the integrated circuit 1200 so as to enhance a display effect of the electronic device according to the light intensity signal. Conversely, when the intensity of the light source L is too weak, the voltage controller 9100 increases the transparency of the liquid crystal layer of the smart film layer 1100 to achieve the best display state or projection state.

Based on the above embodiments, the present disclosure provides an electronic device and a display projection system with a smart film layer so as to reduce a thickness of the overall structure of an electronic device. An electronic device is maintained in the best display state or projection state with a combination of a display projection system and a smart film layer in any environment.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

1. An electronic device, comprising:
an integrated circuit configured to output a control signal; and
a smart film layer coupled to the integrated circuit, the smart film layer comprising:
a first substrate;
a second substrate located on the first substrate;
a liquid crystal layer located between the first substrate and the second substrate;
a transparent glue layer located on the second substrate;
a cover located on the transparent glue layer; and
at least one touch electrode layer located between two of the first substrate, the liquid crystal layer, the second substrate, the transparent glue layer, or the cover, wherein:
the at least one touch electrode layer is configured to transmit a touch signal according to the control signal of the integrated circuit when the at least one touch electrode layer is in a non-conductive state, and
the at least one touch electrode layer is configured to control the liquid crystal layer to present a plurality of transparent states according to the control signal of the integrated circuit when the at least one touch electrode layer is in a conductive state.

2. The electronic device of claim 1, wherein the at least one touch electrode layer is located between the first substrate, the liquid crystal layer, and the second substrate, wherein a range of a transparency of the plurality of transparent states is between 0% and 100%, wherein when the transparency is 100%, the liquid crystal layer is completely transparent, wherein when the transparency is 0%, the liquid crystal layer is completely nontransparent.

3. The electronic device of claim 2, wherein the smart film layer comprises at least one conductive layer, wherein the liquid crystal layer comprises a first side and a second side, wherein the first side is opposite to the second side, wherein at least a subset of the at least one conductive layer is located at the first side of the liquid crystal layer, and the at least one touch electrode layer is located at the second side of the liquid crystal layer, wherein the at least one conductive layer, when in a conductive state, is configured cooperate with the at least one touch electrode layer to control the liquid crystal layer to present the plurality of transparent states.

4. The electronic device of claim 3, wherein each of the at least one conductive layer and the at least one touch electrode layer comprises one of Indium Tin Oxide (ITO), nano silver, or metal mesh.

5. The electronic device of claim 4, wherein the electronic device comprises a first area and a second area, wherein the at least one conductive layer and the at least one touch electrode layer, which are located in the first area, are configured to control the liquid crystal layer to present in a first transparent state, and the at least one conductive layer and the at least one touch electrode layer, which are located in the second area, are configured to control the liquid crystal layer to present in a second transparent state, wherein the first transparent state is a same as or different from the second transparent state.

6.-8. (canceled)

9. The electronic device of claim 1, wherein each of the first substrate and the second substrate comprises one of a glass substrate or a polymer substrate, wherein the liquid crystal layer comprises one of polymer dispersed liquid crystal (PDLC) or Multiple Stability Liquid Crystal (MSLC).

10. The electronic device of claim 1, wherein the electronic device further comprises a first optical sensor, wherein the first optical sensor is coupled to the integrated circuit and is configured to sense an intensity of a light source so as to control the smart film layer to present in the plurality of transparent states through the integrated circuit according to the intensity of the light source.

11. The electronic device of claim 10, wherein the electronic device further comprises a second optical sensor and a backlight plate, wherein the second optical sensor and the backlight plate are coupled to the integrated circuit, wherein the second optical sensor is located between the backlight plate and the smart film layer and is configured to sense an intensity of the backlight plate so as to control the smart film layer to present in the plurality of transparent states and control a luminance of the backlight plate through the integrated circuit according to the intensity of the backlight plate.

12. The electronic device of claim 11, wherein the electronic device comprises a display screen, wherein the display screen comprises an array layer, wherein the smart film layer and the second optical sensor are located between the array layer of the display screen and the backlight plate.

13. A display projection system, comprising:
an electronic device, comprising:
an integrated circuit configured to output a control signal;
a first optical sensor coupled to the integrated circuit and configured to sense an intensity;
a smart film layer coupled to the integrated circuit and configured to transmit a touch signal according to the control signal or control a liquid crystal layer of the smart film layer to present a plurality of transparent states;
a backlight plate; and
a second optical sensor disposed between the backlight plate and the smart film layer; and
a projector coupled to the integrated circuit and configured to project an image on the smart film layer of the electronic device, wherein the first optical sensor is configured to sense the intensity of a light source so as to control the liquid crystal layer of the smart film layer to present the plurality of transparent states through the integrated circuit according to the intensity of the light source.

14. The display projection system of claim 13, wherein the electronic device comprises a plurality of first areas and a plurality of second areas, wherein the liquid crystal layer in the plurality of first areas is controlled to present in a first transparent state, and the liquid crystal layer in the plurality of second areas is controlled to present in a second transparent state, where the first transparent state is a same as or different from the second transparent state.

15. The display projection system of claim 13, wherein:
the smart film layer comprises at least one touch electrode layer,
the at least one touch electrode layer is configured to transmit the touch signal according to the control signal when the at least one touch electrode layer is in a non-conductive state, and
the at least one touch electrode layer is configured to control the liquid crystal layer to present the plurality of transparent states according to the control signal when the at least one touch electrode layer is in a conductive state.

16. The display projection system of claim 13, wherein the second optical sensor is configured to sense an intensity of the backlight plate.

17. The display projection system of claim 16, wherein a luminance of the backlight plate is controlled based upon the intensity of the backlight plate.

18. A display projection system, comprising:
an electronic device, comprising:
an integrated circuit configured to output a control signal;
a backlight plate;
an optical sensor coupled to the integrated circuit and configured to sense an intensity of the backlight plate; and
a smart film layer coupled to the integrated circuit and configured to transmit a touch signal according to the control signal or control a liquid crystal layer of the smart film layer to present a plurality of transparent states, wherein the optical sensor is disposed between the backlight plate and the smart film layer; and
a projector coupled to the integrated circuit and configured to project an image on the smart film layer of the electronic device, wherein the optical sensor is configured to control the liquid crystal layer of the smart film layer to present the plurality of transparent states through the integrated circuit.

19. The display projection system of claim 18, comprising a second optical sensor coupled to the integrated circuit.

20. The display projection system of claim 19, wherein the second optical sensor is configured to sense an intensity of a light source different than the backlight plate.

21. The display projection system of claim 18, wherein a luminance of the backlight plate is controlled based upon the intensity of the backlight plate.

22. The display projection system of claim 18, wherein:
the smart film layer comprises at least one touch electrode layer,
the at least one touch electrode layer is configured to transmit the touch signal according to the control signal when the at least one touch electrode layer is in a non-conductive state, and
the at least one touch electrode layer is configured to control the liquid crystal layer to present the plurality of transparent states according to the control signal when the at least one touch electrode layer is in a conductive state.

23. The electronic device of claim 1, wherein:
the smart film layer comprises at least one conductive layer,
the at least one conductive layer and the at least one touch electrode layer are between the first substrate and the second substrate,
the at least one conductive layer is disposed on a first side of the liquid crystal layer, and
the at least one touch electrode layer is disposed on a second side of the liquid crystal layer opposite to the first side.
